(19) United States
(12) Patent Application Publication
(10) Pub. No.: US 2002/0124054 A1
(43) Pub. Date: Sep. 5, 2002

(54) Medical system architecture based on microsoft OLE/OCX and automation or, respectively, atomic

(76) Inventors: Karlheinz Dorn, Kalchreuth (DE); Detlef Becker, Moehrendorf (DE); Dietrich Quehl, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 09/881,492

(22) Filed: Jun. 14, 2001

Related U.S. Application Data
(63) Continuation-in-part of application No. 08/883,303, filed on Jun. 27, 1997, now abandoned.

(30) Foreign Application Priority Data
Jun. 27, 1996 (DE) 19625841.3

(51) Int. Cl. G06F 15/16; G06F 9/46

(52) U.S. Cl. 709/217; 709/313

(57) ABSTRACT

A medical system architecture with a modality (1 through 4) for the acquisition of images, a means (5 through 8, 11, 12) for processing the images and a means (9) for the transmission of the images. The means (5 through 8, 11, 12) for processing comprises a digital image system with a computer that works according to a method for data exchange between various application programs (OLE) with graphic control elements and a standard for OLE Custom Controls (OCX), whereby an OCX software component (18) is allocated to every individual process limited by boundaries, these OCX software components being expanded with an OLE Automation or ATOMIC remote control component (19, 22, 27 through 31, 35 through 41) so that the devices and processes can be remote controlled without any limitations caused by address space or computer boundaries.

### CROSS-REFERENCE TO RELATED APPLICATION

The present application is a Continuation-In-Part Application of Ser. No. 08/883,303, Filed Jun. 27, 1997.

### BACKGROUND OF THE INVENTION

1. Field of the Invention

The present invention is directed to a medical system architecture with a modality for acquiring images, a device for processing the images and a device for the transmission of the images, whereby the device for processing comprises a digital imaging system with a computer that works according to a method for data exchange between various application programs (OLE) with graphic control elements and a standard for OLE Custom Controls (OCX), whereby an OCX software module is loaded into the virtual address space of every process.

2. Description of the Related Art

As described, for example, in the book by Heinz Momeburg, “Bildgebende Systeme fuir medizinische Diagnostik”, Erlangen, Publicis MCD-Verlag, 3rd Edition 1995, pages 680-697, medical systems are becoming more and more complex, whereas the degree of expansion of medical systems increases to the same proportion. As a result thereof, however, an extremely flexible architecture is required.

Previously known architectures were not designed in compliance with distributed, asynchronous software and reusable, self-contained software components. In other words, a monolithic software architecture approach was used.

Despite the use of object orientation, further, the simple use of class libraries prevents the design of flexible and re-employable components since, in reality, classes are not truly re-employable on a large scale. One of the reasons of this lack of reusability is the outgrowth of C++ inheritance where lots of different classes derive from others and result in huge unmaintainable software blocks.

### SUMMARY OF THE INVENTION

The present invention is based on the object of providing software components (or objects) that exhibit a behavior that is independent from other components as far as possible. Further the connections between the components should be invisible in relationship to the location of these components (or objects), so that they can either all be combined in one process (local server), or combined in different processes (local servers) of a computer, or can be distributed into different processes (local servers) located at several computers connected to a network.

For purposes of the present invention, an independent component is defined as a substantially self-contained component-having-no link-time (by design) dependency on-other software components and generally capable of operation independent from the execution of other components.

The transfer of medical images between self-contained components (and other programs as well) is carried out by usage of the DICOM protocol. The DICOM protocol enables image transfer between imaging modalities of different manufacturers. DICOM (Digital Imaging and Communications in Medicine) is an industrial standard which was developed by the American College of Radiology (ACR) and the National Electrical Manufacturers Association (NEMA). DICOM 3.0 is implemented by the Radiology Society of North America (RSNA) Electronic Communications Committee. DICOM is discussed at http://www.rsna.org/practice/DICOM/dicom.html on the internet.

The design of the self-contained software components (especially non-GUI components) follows the rules of the software ICs for high level application frameworks, which is the subject of co-pending application Ser. No. 09/773,949, filed Feb. 1, 2001, which is a CIP application of the application Ser. No. 08/675,846, filed Jul. 6, 1996, and which is incorporated herein by reference.

The components are coupled loosely by means of an location transparent (invisible) event propagation mechanism. The reference to invisible connections refers to location-transparent connections, such as that disclosed in ATOMIC (Asynchronous Transport Optimizing observer-pattern-like approach supporting several Modes (client/server—push/pull) for an IDL-less Conmnunication subsystem, which is the subject of co-pending patent application Ser. No. 08/676,859, filed Jul. 7, 1996, and which is incorporated herein by reference).

The above and other objects and advantages are inventively achieved in that the system architecture is fashioned such that the OCX software components are-extended by a remote control component, which supports an asynchronous working model needed for non-blocking GUIs. The self-contained components can be distributed within a single computer as well as over a network of computers without the limitations found in previous software architectures. A good solution of the objects derives by combination of software components (or objects) and a distributed event propagation mechanism.

It has proven advantageous when the remote control component is an OLE Automation interface and the remote control ensues according to the OLE Automation Standard. Inventively, the remote control component can be an automation interface module.

An alternative advantageous solution derives when the remote control ensues with software-IC connections, for example according to the ATOMIC Standard. According to the invention, the remote control component can be a connectable/remote interface module in this case.

It has proven advantageous when the method for data exchange is the Microsoft standard OLE and the standard for OLE Custom Controls is the Microsoft standard OCX.

The present invention provides that the medical system architecture can employ Microsoft OCX for producing components for graphic user surfaces within a Microsoft container process, whereby Microsoft OCX can be combined with OLE Automation and/or with software ICs (for example, the ATOMIC standard) for distributed propagation of events within all levels of the architecture.

An important new feature is the combination of Microsoft OLE Custom Controls (OCX), a newly created software technology, with another, general Microsoft Scripting Standard interface that serves as a fully distributable network-wide mechanism for the propagation of an event (referred to as an event propagation mechanism) as soon as network-wide OLE is available in order to obtain a realistic Model View Controller concept (MVC) based system architecture.

Preferably, Microsoft OCX can also be employed for producing components for graphic user surfaces (Graphical User Interface (GUI) components) within a Microsoft container process. As a result thereof, one obtains truly binarity compatible, re-employable GUI components.

Further, Microsoft OCX can be inventively combined with OLE Automation and with software-IC connections for the distributed propagation of an event (referred to as an event propagation) with local between all components. This provides the flexibility for the distribution of components over the network combined with binary-compatible interfaces based on shared libraries. Objects which are distributable and GUI dependent as well as not GUI-dependent are thus obtained.

This combination of software-ICs and OCX/Automation interfaces enables an execution architecture to define executable processes not by design but mainly by configuration of shared program components (shared libraries (or DLLs—dynamic link libraries)) at runtime together with the possibility of scripting.

### BRIEF DESCRIPTION OF THE DRAWINGS

The present invention is explained in greater detail below on the basis of exemplary embodiments shown in the drawing. Shown are:

FIG. 1 is a block diagram of a medical computer network of the related art;

FIGS. 2, 3 4 and 5 are functional block diagrams showing the inventive collaboration of the software components according to a first exemplary embodiment; and

FIG. 6 is a functional block diagram illustrating the inventive collaboration of the software components according to a second exemplary embodiment.

### DETAILED DESCRIPTION OF THE PREFERRED EMBODIMENTS

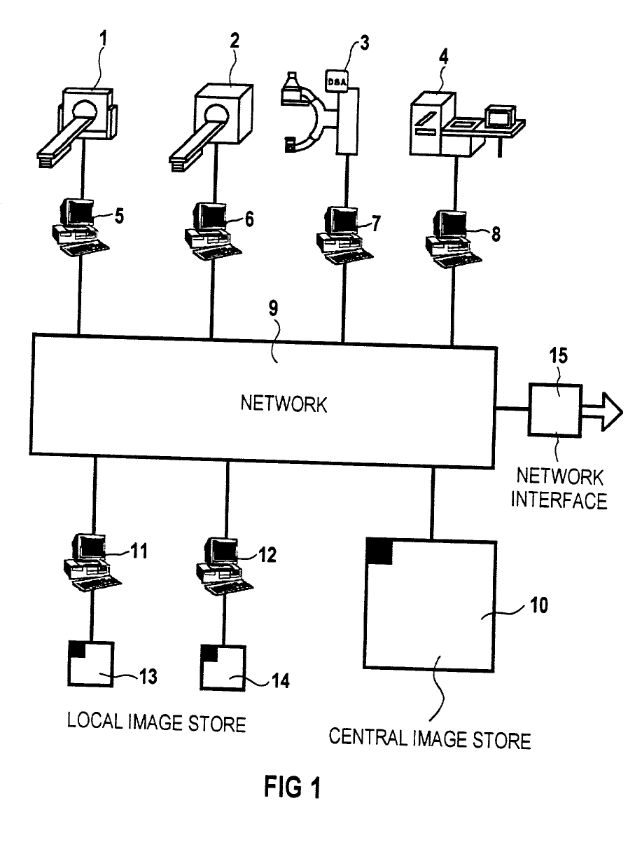

FIG. 1 shows the system architecture of a medical computer network. The modalities 1 through 4 serve for the acquisition of medical images and can comprise, for example a CT unit 1 for computer tomography, an MR unit 2 for magnetic resonance, a DSA unit 3 for digital subtraction angiography and an X-ray unit 4 for digital radiography as image-generating systems. Work stations 5 through 8 with which the modalities 1 through 4 can be controlled and the acquired medical images can be processed and stored can be connected to these modalities 1 through 4. For example, such work stations 5 through 8 are very fast small computers having one or more fast processors.

The work stations 5 through 8 are connected to an image communication network 9 for the distribution of the generated images and for communication. Thus, for example, the images generated in the modalities 1 through 4 can be stored in a central image store, or memory, 10 or can be forwarded to other work stations 5 through 8.

Further work stations that can be connected to a local image store, or memory, 13 and 14, which is for example a jukebox, can be connected to the image communication network as diagnosis consoles 11 and 12. The images that are acquired and deposited in the central image store 10 can be subsequently called in the diagnosis consoles 11 and 12 and be deposited in the local image store 13 and 14 from which they can be directly available to a diagnostician working at the diagnosis consoles 11 or 12.

A network interface 15 via which the internal image communication network 9 is connected to a global data network can be connected to the image communication network 9, so that the standardized data can be exchanged worldwide with different networks.

This image data exchange via the image commnunication network 9 thereby ensues according to the DICOM standard that is widespread in medical systems, which is an industrial standard for the transmission of images and other medical information between computers for enabling digital communication between diagnostic and therapy apparatus of different manufacturers.

The complexity of medical imaging systems is increasing rapidly. Thus a major requirement on a system architecture is the reuse of proven parts of the software. More and more imaging modalities are connected to a clinical network and must be able to inter-operate with each other. This requires that a system architecture enables the software to use network wide services such as image stores on remote computers. Although the image acquisition systems of the modalities (MR, CT, etc.) are completely different, there is a lot of functionality which is identical for all modalities (e.g. patient registration, archiving, networking, image viewing, image processing, filming, etc.). The system architecture must provide means for reuse of such commonly used functionality designed for one of the modalities on others modalities without programmiing. This requires that this software does not depend on modality specific environment.

The present invention deals with these requirements by defining a system architecture according to the MVC concept (Mode View Controller). A functionality or so-called application (e.g. patient registration) is divided into three parts (i.e. 3 tiers), the view (a thin client) which provides means for a graphical user interface, a controller that contains the business logic (validation of patient data like sex, weight, age, etc.), and one or more models (services) like database systems or network connections. These three parts (tiers) of an application are build according to the software-IC concept, which allows distribution and runtime-configuration in different processes. These three parts (tiers) of an application are coupled tightly as a result of their semantics.

The coupling of different applications is loosely by means of events. An example of loosely coupling is the event propagated by the image acquisition application after the acquisition finished. The image viewing application can display the newly acquired images as a reaction of this event. If there is no image viewing application configured on this modality, the event is ignored. Tight coupling of these applications (e.g. by link-time dependencies) would always require the image viewing application to be installed on this computer. This loosely coupling between applications allows them to be reused all together or in parts by other modalities by simply configuring these components (software-ICs) at runtime.

The present invention combines the advantages of both, the software-ICs and the OLE/OCX technology by applying a remote control component. The software-ICs provide means for building self-contained and fully distributable components with a location transparent and asynchronous (non-blocking) event propagation mechanism. The OCX technology allows the usage of different progratming languages (e.g. Visual C++, Visual Basic, etc.). The remote control comrponent uses the event propagation mechanism according to ATOMIC as the external asynchronous interface to be used for communication between components and the synchronous OLE automation interface as the internal interface to the component. The synchronous internal automation interface of the remote control component allows non-thread-safe programming of the component while the asynchronous (non-blocking) external interface provides means for queuing of the input and output events. Another advantage of the remote control component is it's role as a mediator between the external and the internal interface and thus allows the modification of the component's program code (business logic) without the risk of changes of the external interface.

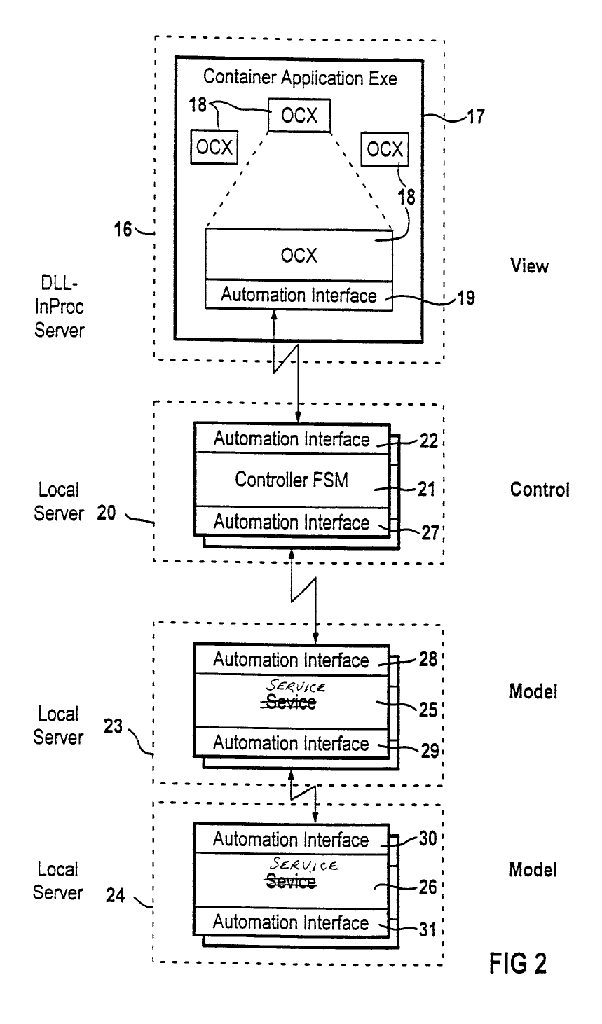

FIG. 2 shows a first example of a software architecture according to the MVC concept (Model View Controller) wherein the view, control and model components are respectively contained in different processes. The view area is located in a dynamic link library (DLL) of an in-process server 16.

A dynamic link library is a collection of object files that are (dynamically) linked (made available) at the run time of a process and that can be simultaneously shared by a plurality of processes. The implementation of a service is realized such that given the in-process server 16 this service must always run in the same process as the client who requires this service. DLLs are particularly suitable therefor since they make the service dynamically available to the process on demand.

The application program, which comprises a plurality of OCX software components 18, is loaded in the server 16. Automation Interface components 19 of the OLE Automation standard are coupled to the OCX components 18 as remote control components. These components make it possible to communicate with other local servers. A controller 21 for coupling the view level with the model level can thus be stored in a second local server 20. This controller 21 is likewise coupled to a corresponding Automation Interface component 22.

The controller 21 is a component from the model view component (MVC) world. The view thereby represents a way of viewing the model. Model and view are coupled via a controller component. This controller component is essentially composed of an automatic state unit, what is referred to as a fmite state machine (FSM).

The model component can be contained in two further local servers 23 and 24 in which the service components 25 and 26 are coupled to one another via further Automation Interface components 27 through 31.

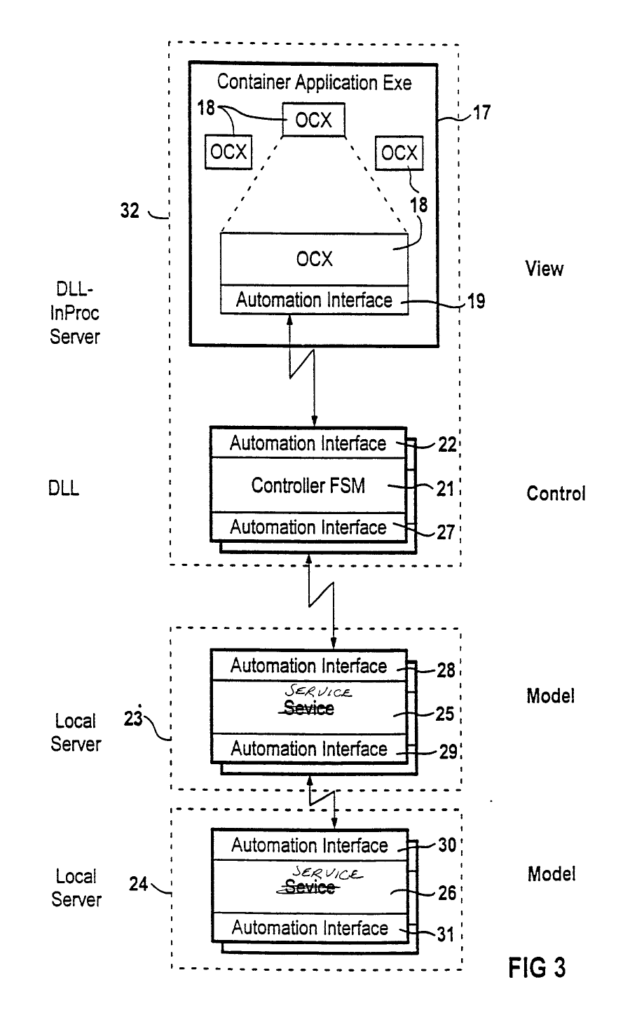

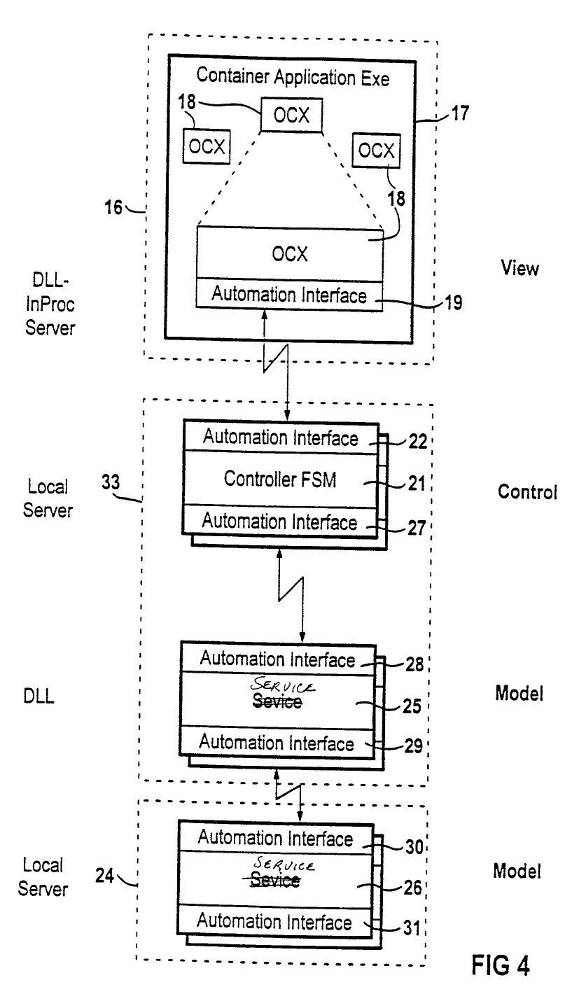

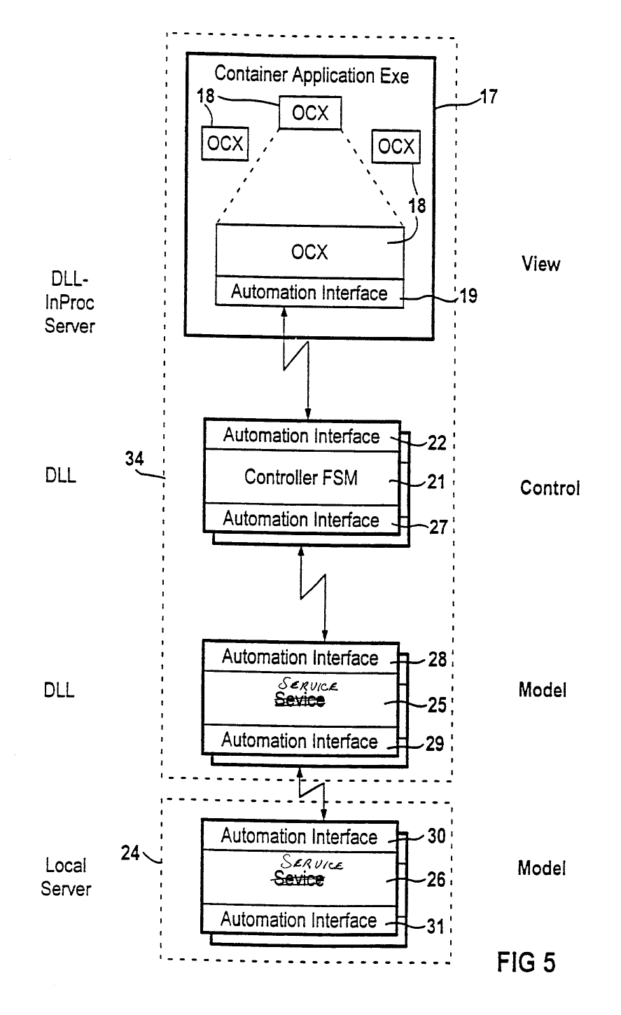

The structure is essentially the same in FIGS. 3 through 5; the configuration of the components into processes is merely different. Whereas all MVC components in the first case according to FIG. 2 are respectively arranged in a separate process, the view and control components in the example according to FIG. 3 are arranged in one process and the model components are arranged in separate processes. This means that the control level of the controller 21 is already located in the same dynamic link library (DLL) of a in-process server 32 as the application program 17 of the view component.

In the subject matter according to FIG. 4, the control and model components are combined in one process and are located in the same dynamic link library (DLL) of the local server 33. Preferably, there is also the possibility of configuring the view, control and model components according to FIG. 5 into one process in the dynamic link library (DLL) of an in-process server 34, whereby a further service component is contained in a further local server 24.

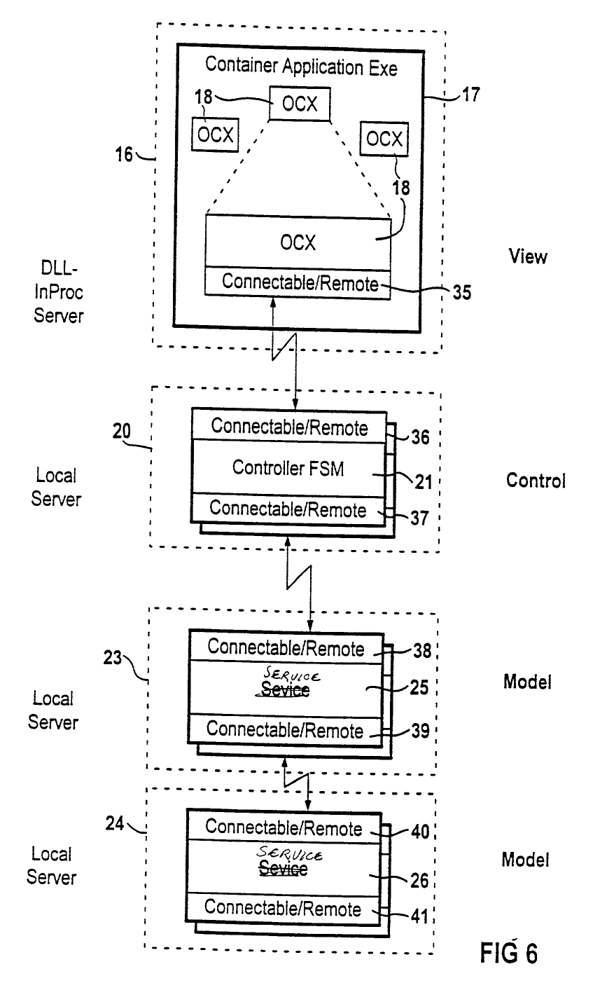

FIG. 6 shows a second example according to the MVC concept (model view controller) that is similar to the example of FIG. 2. Here, too, the view area is again located in a dynamic link library (DLL) of the in process server 16. What are referred to as software-IC connection 35 (connectable/remote) are coupled to the OCX software components 18 of the application program 17 loaded in the server 16 as remote control components instead of the Automation Interface components 19. The communication with other local servers 20, 23 and 24 is enabled with these components. The controller 21 in the local server 20 can thus be for coupling the view component with the model component. This controller is likewise coupled to corresponding software-IC connections 36 and 37. The model component is arranged in the local servers 23 and 24 in which the service components 25 and 26 are contained via further software-IC connections 38 through 41, which is the subject of co-pending patent application Ser. No. 09/773,949, filed Feb. 1,2001, which is a CIP application of the application Ser. No. 08/675,846, filed Jul. 6, 1996, and which is incorporated herein by reference.

These connectable/remote software-IC remote control components are fully distributable input/output events based on an event-communicating network that is dynamically loadable and configurable by input/output connections points.

The advantage of this inventive proposal is its flexibility and, even more, its productivity for achieving software components which are re-employable in various medical system product architectures.

The software-IC connections allow a truly arbitrary distribution of the components in executable processes without ending up in lock-up states as can be the case in other communication mechanisms (for example, Corba) without source code modification. The components can even be arbitrarily combined at the run time as a result thereof. Another advantage is that the connections can be n:m connections (n suppliers and m consumers), which is usually not possible in traditional systems, whereby the connection parties anonymously find one another at the run time according to ATOMIC.

In addition, the component connections also differ from traditional connections in that event data are transmitted on the connections and no remote methods are called. The usage of remote methods makes it difficult to adapt the business logic of a component to the needs of new imaging systems without braking the signature and the semantic of the component's external interface.

An example of a use case for the present medical system architecture is shown in an Appendix, attached hereto. The example utilizes the terms of the present application and includes structure corresponding to the figures of the present application. Further, GUIs and a complete source code for all three tiers and the ATOMIC based communication source code for the remote control component is presented.

Although other modifications and changes maybe suggested by those skilled in the art, it is the intention of the inventors to embody within the patent warranted hereon all changes and modifications as reasonably and properly come within the scope of their contribution to the art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A medical system architecture, comprising:
a modality for acquiring images,
a means for processing the images, said means for processing includes a digital image system with a computer that works according to a standard for object linking and embedding method for data exchange between various application programs with graphical control elements and a standard for object linking and embedding custom controls, wherein a standard for object linking and embedding custom controls software component is allocated to every individual process limited by address space boundaries,
means for expanding the standard for object linking and embedding custom controls software components with a remote control component for asynchronous communication so that devices and processes can be remote controlled without any limitations caused by address space or computer boundaries, and
a means for the transmission of the images,

2. A medical system architecture according to claim 1, wherein said remote control component is an OLE Automation interface.

3. A medical system architecture according to claim 2, wherein the remote control ensues according to an OLE Automation standard.

4. A medical system architecture according to claim 1, wherein the remote control component is an Automation Interface component.

5. A medical system architecture according to claim 1, wherein the remote control ensues with software-IC connections.

6. A medical system architecture according to claim 1, wherein the remote control ensues according to the ATOMIC standard.

7. A medical system architecture according to claim 5, wherein the remote control component is a connectable/remote interface component.

8. A medical system architecture according to claim 6, wherein the remote control component is a connectable/remote interface component.

9. A medical system architecture according to claim 1, wherein said means for transmitting uses for data exchange the standard for object linking and embedding.

10. A medical system architecture according to claim 1, wherein a standard for said standard for object linking and embedding Custom Controls is the component standard Microsoft OCX.

11. A medical system architecture according to claim 1, further comprising:
means for use of software component technology for producing components for graphic user interfaces contained within a process.

12. A medical system architecture according to claim 1, further comprising:
means for combining software component technology with standard for object linking and embedding Automation for distributed propagation of an event within a control level and between the control levels.

13. A medical system architecture according to claim 1, further comprising:
means for combining software component technology with software-IC connections for the distributed propagation of an event within a control level and between the control levels.
